(19) United States
(12) Patent Application Publication
(10) Pub. No.: US 2013/0048728 A1
(43) Pub. Date: Feb. 28, 2013

(54) METHOD AND SYSTEM FOR PROTECTING BULK PRODUCT

(71) Applicants: Gerhard Frederick Swiegers, Thirroul (AU); Neil Mulcahy, Port Melbourne (AU); Sandra Laminski, Frankston (AU); John Kraft, Newport (AU)

(72) Inventors: Gerhard Frederick Swiegers, Thirroul (AU); Neil Mulcahy, Port Melbourne (AU); Sandra Laminski, Frankston (AU); John Kraft, Newport (AU)

(73) Assignee: AGTECHNIX PTY LIMITED, Carrum Downs (AU)

(21) Appl. No.: 13/499,584

(22) PCT Filed: Sep. 29, 2010
(86) PCT No.: PCT/AU10/01280

§ 371 Date: May 16, 2012

(30) Foreign Application Priority Data
Oct. 2, 2009 (AU) 2009904812

(51) Int. Cl. G06K 7/10; B05D 5/06; C09K 11/06; G06K 19/06

(52) U.S. Cl. 235/454; 427/162; 427/157; 252/301.16

(57) ABSTRACT

Methods and systems for identifying a batch of bulk product comprising particles are disclosed. One such method comprises the steps of: identifying at least one particle in the batch of bulk product that comprises data for identifying the quantity of bulk product (510); verifying that the data is representative of the batch of bulk product by detecting presence of a first marker applied to the at least one particle and one or more other particles in the quantity of bulk product that do not comprise the data (520); and retrieving the data from the at least one particle and processing the data to identify the quantity of bulk product (530).

### TECHNICAL FIELD

The present invention relates to a method and system for identifying, verifying, tracking, and/or authenticating bulk product comprising particles such as seeds, grains, and other agriculturally-related products, to thereby protect such products and purchasers thereof from counterfeiting and illegal multiplication.

### BACKGROUND

Various attempts have been made to verify, track, and authenticate seeds, grains, and other bulk, flowable, agriculturally-related products, so as to dissuade or prevent counterfeiting and illegal multiplication of such products. A major driver for these attempts has been the development, for seeds, grains, and related agricultural products, of:
new coating and other treatments that enable the products to germinate, grow, or act in an optimum or desirable way, with a minimum of interference by external factors such as weather (e.g., drought or flood), pests, and/or diseases;
plant breeding programmes that generate new plant strains and their seeds, which are adapted for maximum yield or other desirable properties, under particular conditions or subject to external factors such as weather, pests, diseases, herbicide and/or chemical resistance; and
biotechnological and genetic modification (GM) techniques that generate new plant strains and their seeds, which are adapted for maximum yield or other desirable properties, under particular conditions or subject to external factors such as weather, pests, and/or diseases.

Seeds, grains, and other products of the types described above are typically developed at great financial cost and may be protected by legally enforceable plant-breeder and other intellectual property rights. However, such rights are frequently difficult to enforce in a practical and cost-effective way.

For example, seeds and grains may be inexpensive to purchase in small quantities and may be subject to inexpensive copying and replication, including by readily-available biotechnological means. The resulting illegally counterfeited product is frequently not easily distinguishable from the authentic product, which may be legally protected. Sales of such counterfeit products have the potential to cause the developers of the original, authentic products to become financially disadvantaged and, in some cases, unable to recoup their investment in developing the product.

Additionally, treated seeds, grains, and other products of the types described hereinbefore are frequently not readily distinguishable from untreated seeds, grains, or related products that do not possess the promised and/or desired properties of the treated products. Accordingly, purchasers of such products are generally unable to satisfactorily verify that a purchased product is in fact the required product. This can lead to failure of crop, which can result in substantial financial loss. In the case of seeds and grains, an additional risk is posed to food-security.

For these and other reasons, a need exists for improved methods and systems for identifying, verifying, tracking, and authenticating seeds, grains, and other bulk products.

### SUMMARY

The present inventors recognised that a need exists for an improved method and system for tagging and identifying batches of seed, grain and other bulk product. The data payload of the taggant should be sufficiently large to accommodate identification of large numbers of batches. The taggant itself should preferably be invisible to the naked human eye but should nevertheless be easily identifiable. Furthermore, to avoid adulteration and/or multiplication, every particle in a batch of bulk product should preferably be identifiable as legitimately forming part of that batch. However, the new method and system must be suitably inexpensive to enable widespread use with low value bulk material.

An aspect of the present invention provides a method for facilitating identification of a batch of bulk product comprising particles. The method comprises the steps of: applying a taggant to a quantity of particles of size approximately equal to particles that comprise the bulk product; applying a first marker to the quantity of particles; and adding the quantity of particles to the batch of bulk product. The taggant comprises data for identifying the batch of bulk product and the first marker is adapted to emit a response to activation that is visible to a naked human eye.

The method may comprise the further step of applying a second marker to all particles in the batch of bulk product. The second marker may be adapted to emit a spectroscopic response to activation that is invisible to a naked human eye.

Another aspect of the present invention provides a batch of bulk product comprising particles. Each particle in the batch has a first marker applied thereto, which is adapted to emit a response invisible to a naked human eye when activated. A portion of the particles also have a taggant and a second marker applied. The taggant comprises data for identifying the batch of bulk product and the second marker is adapted to emit a response visible to a naked human eye in response to activation.

Another aspect of the present invention provides a method for identifying a batch of bulk product comprising particles. The method comprises the steps of: identifying at least one particle in the batch of bulk product that comprises data for identifying the quantity of bulk product; verifying that the data is representative of the batch of bulk product by detecting presence of a first marker applied to the at least one particle and one or more other particles in the quantity of bulk product that do not comprise the data; and retrieving the data from the at least one particle and processing the data to identify the quantity of bulk product. Presence of the first marker is detectable in response to activation of the first marker.

### BRIEF DESCRIPTION OF THE DRAWINGS

A small number of preferred embodiments of the present invention are described hereinafter, by way of example only, with reference to the accompanying drawings in which:

FIG. 1 is a photograph taken under high magnification by an optical microscope of a DataDot microdot taggant;

FIG. 2 is a flowchart of a method for facilitating identification of a batch of bulk product comprising particles in accordance with an embodiment of the present invention;

FIG. 3 is a photograph taken under high magnification by an optical microscope of a DataDot microdot taggant attached to a seed pellet;

FIGS. 4A and 4B are photographs of a batch of seed pellets, including a seed pellet to which a DataDot hologram microdot taggant is attached; and

FIG. 5 is a flowchart of a method for identifying a batch of bulk product comprising particles in accordance with an embodiment of the present invention.

### DETAILED DESCRIPTION

Embodiments of the present invention provide a method and system for identifying seeds, grains, and other bulk products, particularly agriculturally-related bulk products, to thereby protect those products and purchasers thereof from counterfeiting and illegal multiplication.

Embodiments of the present invention employ concealed taggants (i.e., taggants that are invisible to a naked human eye), which is desirable for increased security. The taggants, which may comprise micro or nano-particulate taggants, are applied to actual particles of the bulk product and/or to other (e.g., artificial) particles of approximately the same size as the bulk product particles. The taggants comprise a data payload sufficient for identifying the specific batch of bulk product the tagged particles form part of. Non-limiting examples of such data include microscopic or nanoscopic alphanumeric characters and/or barcodes which are visible and readable by a human eye under high magnification using a suitable optical or electron microscope. Preferably, the data includes sufficient information to characterise individual batches of the bulk product.

Concealed taggants (i.e., taggants invisible to a naked human eye) are desirable for increased security. However, a key problem in this regard is the identification of such taggants within a batch of bulk product, particularly if the ratio or proportion of taggants to particles in the batch is small. Accordingly, in embodiments of the present invention, a marker such as a luminescent dye that glows or luminesces in a manner visible to the naked human eye when illuminated with light of a particular wavelength or frequency, is applied to the particles to which the taggants are applied. The marker may, for example, be applied as a coating or be included in the materials used to manufacture particles such as seed pellets. The presence of the marker enables those individual seeds, grains, or other particles that have taggants attached to be readily identified and easily picked out from a batch of bulk product for inspection and retrieval of the taggant data.

In certain embodiments of the present invention, a concealed batch marker that is preferably invisible to the naked human eye is applied to all of the seeds, grains or particles in a batch of bulk product. The batch marker may, for example, exhibit a unique or unusual spectra deriving from the phenomena of luminescence, absorption, isotopic abundance, or other spectroscopic techniques and the like, which become identifiable only upon interrogation with sensitive electronic detectors and/or measuring devices. The presence of the batch marker enables all the particles in a batch of bulk product to be linked, thus enabling verification that data retrieved from a particular taggant is representative of a particular batch of bulk product. Furthermore, presence of the batch marker enables detection of adulteration (e.g., impurities in the batch) and/or multiplication (e.g., dilution of the batch with other particles).

Combinations of the foregoing taggants, markers and batch markers advantageously enables batches of bulk product to be identified and verified in a cost effective manner that is suitable for bulk product of low value. The taggants may be easily and inexpensively identified and interrogated, particularly when coated with the luminescent marker dyes. Because of the ease with which they can be identified, the taggants need only be incorporated into a small portion of the seeds, grains, or other bulk product within a particular batch. This makes for a particularly economical application, especially since the luminescent marker dyes used for identification of the taggants need only be applied to the small portion or fraction of particles to which the taggants have been attached. Furthermore, electronic detectors and/or measuring devices are far more sensitive than the human eye and are thus capable of detecting extremely small quantities of suitable markers such as spectroscopic markers. This enables the economical and inexpensive application of such markers to all of the seeds, grains, or other particles within a batch, thereby ensuring that each seed, grain or other particle within the batch is marked and identifiable. The batch marker does not necessarily encode any data, but links all of the seeds, grains, or other particles within a batch to each other.

Taggants used in embodiments of the present invention include Datadot-DNA microdots, which are available from DataDot Technology (Australia) Pty Ltd (www.datadotdna.com/australia/dtal_technology_indetail_dot.htm).

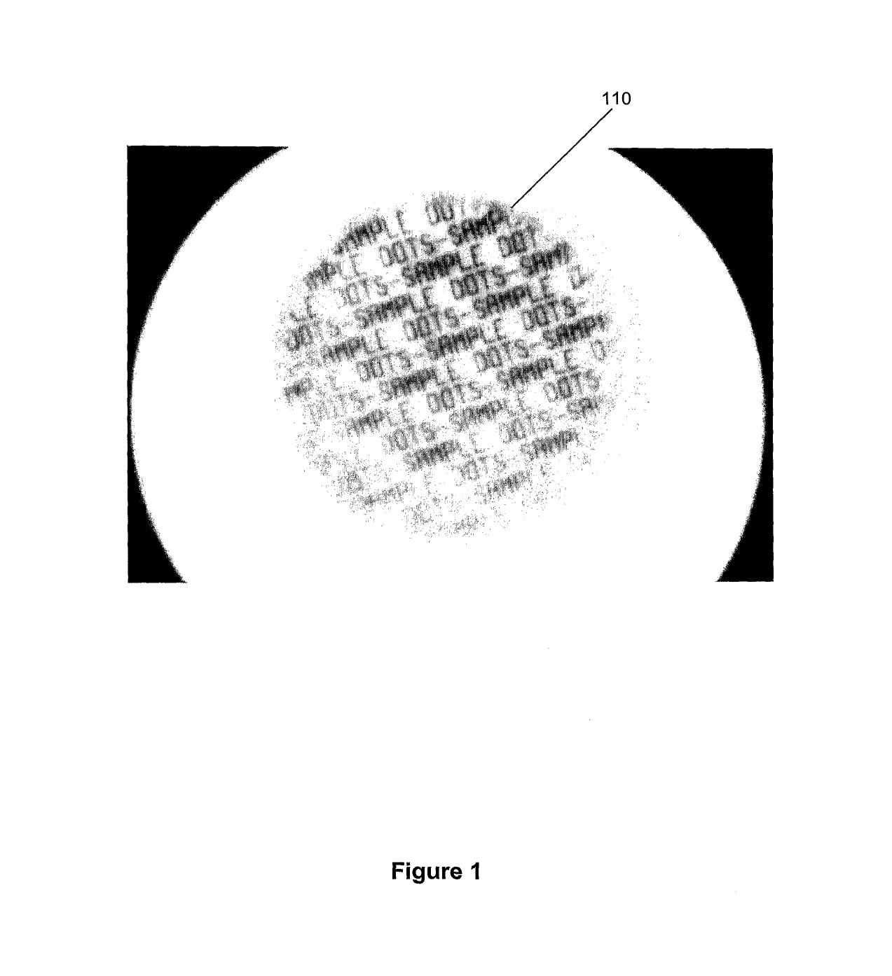

FIG. 1 illustrates a Datadot-DNA microdot 110 under high magnification by an optical microscope. As can be seen from FIG. 1, the Datadot-DNA microdot 110 comprises a tiny disc, about the size of a grain of sand, laser-etched with multiple lines of code or text. In certain instances, a unique code may be used for each item or asset the microdots are to be applied to and stored on a worldwide verification database. In other instances the microdot simply carries an identifier of the asset or item—for example, the full Vehicle Identification Number (VIN) as issued by a car manufacturer.

However, those skilled in the art will appreciate that numerous other suitable microdots and taggants may alternatively be used to practise embodiments of the present invention. For example, smaller dots that can be employed for batch identification by using a distribution of code's within a batch of product. In such circumstances, the dots may have only a single character and the distribution of the various characters may be statistically determined.

Particular marker dyes used in embodiments of the present invention to identify particles with taggants applied thereto include luminescent or fluorescent dyes that glow when activated or illuminated with light of a particular wavelength or frequency. The marker dye may be selected to glow with a colour that maximizes contrast visible to the human eye relative to the colouring of the particles themselves. Examples of such marker dyes include, but are not limited to the following families of optical brighters: the UV-Tex and Tinopal (Manufactured by Ciba), Blankophor (manufactured by Bayer), Leucophor (manufactured by Clariant), and Photine (manufactured by Hickson and Welch).

Spectroscopic markers used in embodiments of the present invention include Datatrace-DNA powders, which are available from DataDot Technology (Australia) Pty Ltd. The Datatrace-DNA powders are inorganic ceramic materials that can be individually traced via their spectroscopic signature using a highly sensitive digital electronic scanner (The Datatrace Authenticator). The Datatrace-DNA powders comprise a micro- or nanoparticulate spectroscopic marker or taggant material. A particular spectroscopic marker used in embodiments of the present invention is DATATRACE code #A powder.

However, those skilled in the art will appreciate that numerous other suitable spectroscopic or other markers may alternatively be used to practise embodiments of the present invention.

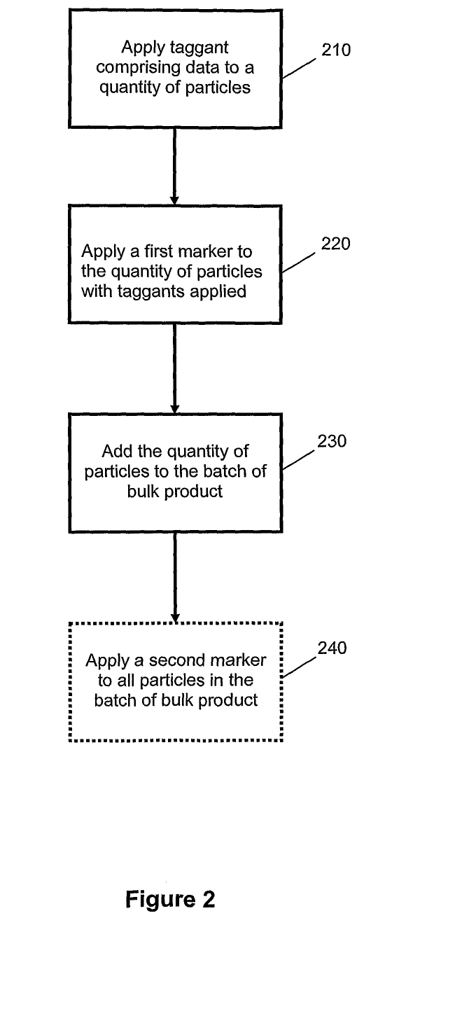

FIG. 2 is a flowchart of a method for facilitating identification of a batch of bulk product comprising particles in accordance with an embodiment of the present invention.

Referring to FIG. 2, a taggant comprising data for identifying the batch of bulk product is applied to a quantity of particles, at step 210. The quantity of particles may comprise particles of the bulk product or other particles of size approximately equal to particles that comprise the bulk product. The taggant may comprise microdots attached to the surface of the quantity of particles, the microdots comprising data for identifying the batch of bulk product.

At step 220, a first marker is applied to the quantity of particles. The first marker is adapted to emit a response to activation that is visible to a naked human eye. The first marker may comprise a coating applied to the quantity of particles that is adapted to emit luminescence in response to illumination by light of a particular wavelength.

At step 230, the quantity of particles is added to the batch of bulk product.

At step 240, a second marker is applied to all the particles in the batch of bulk product. The second marker is adapted to emit a spectroscopic response to activation that is invisible to a naked human eye. The second marker may comprise a coating applied to all particles in the batch of bulk product that is adapted to emit a spectroscopic response when activated. It should be noted that step 240 may not be essential to all embodiments of the present invention.

### Example 1

The following example relates to the application of a taggant (Datadot-DNA microdots) to manufactured seed pellets.

Three batches of between 60,000 and 100,000 seeds were taken from multi-ton lots of seeds and were built up into seed and grit pellets as follows. The grit was pelleted with a zeolite powder to a build-up percentage of 150% of the size of the original seed. A violet pigment was included as a colourant, violet being the darkest colour that is commonly used in coated seeds. Polybright powder was added at 15-20 g per kg of pelleted seed as a shine and a standard polymer mix was used to bind the powder to the grit. Between 5,000 and 10,000 microdots were added to 10-15 ml of polymer mix and added to the pelleted seed at the end of the process as a final binding for the pellets. The microdots were introduced into clear/white polymer mix as opposed to the coloured mix and the resulting pellets were dried on a static dryer.

The first batch comprised 90,000 pellets, to which 10,000 microdots of diameter 1.0 mm were added. The second batch comprised 60,000 pellets, to which 10,000 microdots of diameter 0.5 mm were added. The third batch comprised 100,000 pellets, to which 5,000 hologram (metallic) microdots were added.

1000 pellets were selected from each of the three batches and examined under a dissecting microscope. The number of pellets with microdots was counted and the results are shown in Table 1, hereinafter.

TABLE 1

| | | | | MICRODOTS | MICRODOTS |
|---|---|---|---|---|---|
| | | | MICRODOTS | PER 1000 | PER 1000 |
| NO. OF | NO. OF | TSW | PER PELLET | PELLETS | PELLETS |
| MICRODOTS | PELLETS | (mean) | (theoretical) | (theoretical) | (actual) |
| 10 000 × 1.0 mm | 90 000 | 13.36 | 1 in 9 | 111 | 68 |
| 10 000 × 0.5 mm | 60 000 | 19.58 | 1 in 6 | 167 | 25 |
| 5000 hologram | 100 000 | 12.60 | 1 in 20 | 50 | 34 |

As can be seen from Table 1, 68 in 1000 pellets included one or more microdots when 1 mm microdots were used, 25 in 1000 pellets included one or more microdots when 0.5 mm microdots were used, and 34 in 1000 pellets included one or more microdots when holographic (metal) microdots were used.

A number of pieces of grit were found to have multiple microdots attached, particularly in the batch with 0.5 mm microdots. In a few cases, 3 or 4 microdots were found stuck to the same pellet.

The microdotted pellets were visually identical to seed pellets without microdots, although the hologram microdots could be seen with careful observation. As such, the microdotted pellets were well concealed and were not generally visible to the naked human eye. When in the batch of pellets, the microdotted pellets did not visually stand out. When picked out of the batch and examined under a microscope, the data from the microdotted pellets could easily be read.

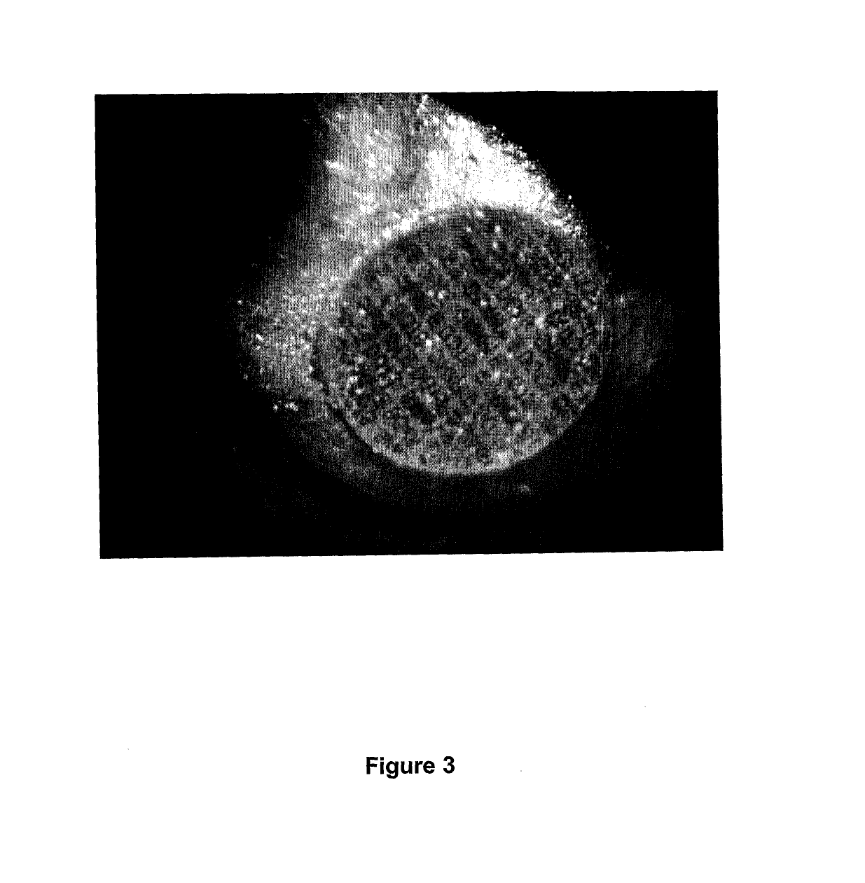

FIG. 3 shows an image as seen through a microscope of a seed pellet with a microdot applied, prepared as described in the example hereinbefore. As can be seen from FIG. 3, the information on the microdot is readily visible and easily readable under a microscope, notwithstanding the dark background colour of the seed pellet.

### Example 2

The following example relates to the application of a flourescent dye marker to the manufactured seed pellets with microdots applied thereto. In this instance, lucerne seed was pelleted with talc using a 100% build up. Violet was again used as the darkest representative colour. The seed was pelleted in an R12 seed pelleting machine. Commercially available fluorescence powder (UV-Tex) was added to the Polybright powder. A sample of 10 000×1.0 mm microdots was added to the final coating of a batch of 100,000 lucerne seeds taken at random from a multi-ton lot. The number of pellets with microdots was counted and the results are shown in Table 2, hereinafter.

TABLE 2

| | | | | MICRODOTS | MICRODOTS |
|---|---|---|---|---|---|
| | | | MICRODOTS | PER 1000 | PER 1000 |
| NO. OF | NO. OF | TSW | PER PELLET | PELLETS | PELLETS |
| MICRODOTS | PELLETS | (mean) | (theoretical) | (theoretical) | (actual) |
| 10 000 × 1.0 mm | 96 000 | 5.79 | 1 in 10 | 100 | 93 |

As can be seen from Table 2, 93 in 1000 pellets included one or more microdots. That is, there was an approximate 1 in 10 chance of finding a microdot on a pellet that had been coated with the fluorescence powder.

The microdotted pellets were visually identical to the seed pellets without microdots. As such, the microdotted pellets were well concealed and were not visible to the naked eye. However, when picked out of the batch and examined under a microscope, the selected pellets had a high likelihood (1 in 10) of bearing a microdot whose information could easily be read.

The microdotted pellets could be easily and readily identified from amongst the coated pellets of the original batch by illuminating the batch with a suitable ultra-violet (UV)-light. The UV light caused the fluorescent dye in the microdotted pellets to glow strongly, thereby identifying the microdotted pellets and enabling them to be picked out for examination under a microscope. The ultra-violet light should ideally emit most intensely at a wavelength that is most strongly absorbed by the fluorescent dye. The amount of UV fluorescent powder used was reduced to 0.2 g per 500 g raw seed and was found to provide good fluorescence even at this low concentration.

Thus, microdotted seed pellets bearing data relating to the batch could be readily identified and removed from the batch for inspection and verification of the data. Even when extremely small proportions of the pellets were coated with microdots and fluorescent dye, these could nevertheless be quickly and easily identified using the UV light and removed from the batch. Accordingly, seed pellet batches can be microdotted in extremely low concentrations, thus providing vastly improved commercial viability.

### Example 3

The following example relates to the application of a spectroscopic marker to manufactured seed pellets. A selection of the original batch of lucerne seed pellets was used. Two samples of the lucerne pellets were prepared as follows:
(i) Lucerne pellets with Thiram+Violet colour+Polybright (10 g) mixed with DATATRACE powder (1 g of code #A) applied to 500 g pelleted seed; and
(ii) Lucerne pellets with Thiram+Violet colour+Polybright (10 g) mixed with DATATRACE powder (0.1 g of code #A) applied to 500 g pelleted seed.

An electronic scanner was used to detect the spectroscopic marker. Results using the electronic scanner gave a reading of 86 counts for the 1 g treatment of code #A and 9 counts for the 0.1 g of code #A. Thus, half-a-kilogram of coated seeds marked with 0.1 g of DATATRACE code #A spectroscopic powder can be readily identified using the electronic scanner. Such scanners are available from DataDot Technology (Australia) Pty Ltd. For example, several versions of the “Datatrace Authenticator” electronic scanner are presently available, including the P1 reader, the P1HP1 reader, the P1HP2 reader, the XP2 reader.

Since the electronic scanner is capable of detecting readings down to 0.5 counts, further tests were performed using even lower levels of spectroscopic marker on a variety of other seeds in a range of other colours.

The following seed pellets were prepared and tested:
(i) Lucerne seed pelleted with talc and polymer mix, 100% build up+Yellow colour+PolyBright (10 g) and DATATRACE powder (0.015 g of code #A) applied to 500 g pelleted seed;
(ii) Poppy seed pelleted with talc and polymer mix, 100% build up+Orange colour+PolyBright (10 g) and DATATRACE powder (0.015 g of code #A) applied to 500 g pelleted seed; and
(iii) Subterranean Clover seed pelleted with talc and polymer mix, 100% build up+Pink colour+PolyBright (10 g) and DATATRACE powder (0.015 g of code #A) applied to 500 g pelleted seed.

The foregoing three seed pellet types were scanned using the scanner. In all cases, the scanner reading was identical at 3 counts for 0.015 g of DATATRACE code #A powder. Thus, half-a-kilogram of coated seeds marked with 0.015 g of DATATRACE code #A spectroscopic powder can be readily identified using the electronic scanner. This is so small a quantity of the marker that it is comercially feasible to mark all of the seeds in a batch.

### Example 4

The following example relates to the application of a taggant (Datadot-DNA microdots), a flourescent dye, and a spectroscopic marker (DATATRACE code #A) to manufactured seed pellets. Three samples of seed pellets as follows were taken from parent batches of 10 kg of each of the seed pellets and prepared in accordance with:
(i) Wheat seed (165 g or 5,000 seeds)+PolyBright mix+Green colour+(500×1.0 mm) microdots;
(ii) Subterranean Clover seed (475 g or 50,000 seeds)+PolyBright mix+Yellow colour+Hologram microdots; and
(iii) Phalaris seed (60 g or 40,000 seeds)+PolyBright mix+Red colour+(2000×0.5 mm) microdots

The PolyBright mix used contained 10 g PolyBright+0.2 g UV-Tex fluorescent powder+0.015 g Datatrace code #A powder.

The remainder of the 10 kg of each of the above seed pellets was treated as above, but without the microdots being present and without the UV-Tex fluorescent powder being present in the PolyBright mix.

The number of pellets with microdots was counted and the results are shown in Tables 3, 4 and 5, hereinafter.

TABLE 3
SUBTERRANEOUS CLOVER

| | | | | MICRODOTS | MICRODOTS |
|---|---|---|---|---|---|
| | | | MICRODOTS | PER 1000 | PER 1000 |
| NO. OF | NO. OF | TSW | PER PELLET | PELLETS | PELLETS |
| MICRODOTS | PELLETS | (mean) | (theoretical) | (theoretical) | (actual) |
| 5000 × hologram | 50 000 | 18.7 g | 1 in 10 | 100 | 77 |

The pelleted seed had a 100% build up of talc and PolyBright. The final colour was a light yellow that gave a reading of 3 counts for code #A using the electronic scanner. The UV fluorescence readily differentiates the marked seeds, albeit not as effectively as with the darker colours.

TABLE 4
PHALARIS HOLDFAST

| | | | | MICRODOTS | MICRODOTS |
|---|---|---|---|---|---|
| | | | MICRODOTS | PER 1000 | PER 1000 |
| NO. OF | NO. OF | TSW | PER PELLET | PELLETS | PELLETS |
| MICRODOTS | PELLETS | (mean) | (theoretical) | (theoretical) | (actual) |
| 2000 × 0.5 mm | 40 000 | 5.0 g | 1 in 20 | 50 | 55 |

The pelleted seed had a 273% build up of talc and PolyBright. The final colour was a light pink. When the seed was scanned using the electronic scanner, it gave a reading of 3 counts for code #A. The UV fluorescence differentiated the microdotted seeds well from the control seeds that had no fluorescent powder; the difference was substantial.

TABLE 5
WHEAT

| | | | | MICRODOTS | MICRODOTS |
|---|---|---|---|---|---|
| | | | MICRODOTS | PER 1000 | PER 1000 |
| NO. OF | NO. OF | TSW | PER PELLET | PELLETS | PELLETS |
| MICRODOTS | PELLETS | (mean) | (theoretical) | (theoretical) | (actual) |
| 500 × 1.0 mm | 5000 | 32.5 g | 1 in 10 | 100 | 61 |

The pelleted seed had a 9% build up of PolyBright. The final colour was green. This seed was coated and marked with microdots in the final polymer layer. When the seed was scanned using the electronic scanner, it gave a reading of 3 counts for code #A. The UV fluorescence differentiates the microdotted seeds very well from the control seeds. The surface area of the wheat seed was the largest trialed.

Each of the above sets of seeds pellets were returned to their original 10 kg parent batches and mixed in thoroughly.

When scanned using the electronic scanner, each of the 10 kg parent batches gave a scanner reading that was identical at 3 counts of DATATRACE code #A. This reading derived from the Datatrace powder that was present in the Polybright powder used on all of the seeds in the entire 10 kg batch. Additionally, when illuminated with UV light of suitable wavelength, the seeds which were present in the sub-batches (i)-(iii) above could be readily identified by the fact that they glowed intensely and visibly to the human eye. When 10-20 of these seeds were picked out of their respective 10 kg batches, 1 or more of the picked out seeds had a microdot attached to them. The information on the microdot could be read using an optical microscope.

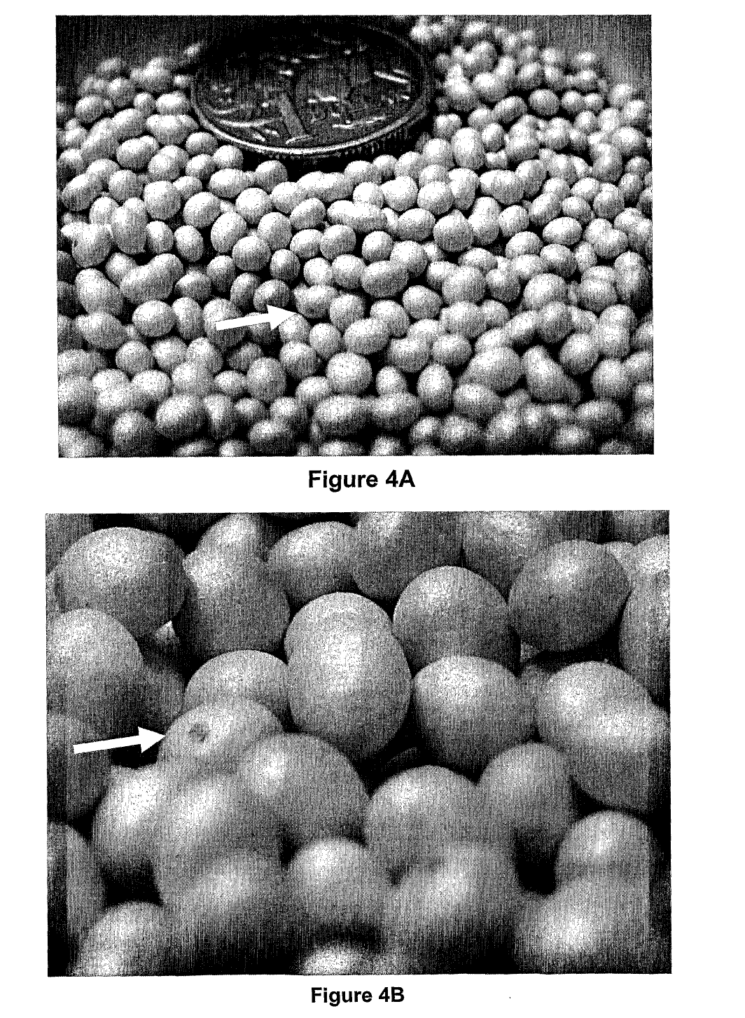

FIGS. 4A and 4B are photographs of a batch of seed pellets, including a seed pellet to which a DataDot hologram microdot taggant is attached. The microdot-tagged seed pellet is indicated by the arrow. All the seed pellets in FIGS. 4A and 4B have been coated with the DATATRACE code #A spectroscopic marker.

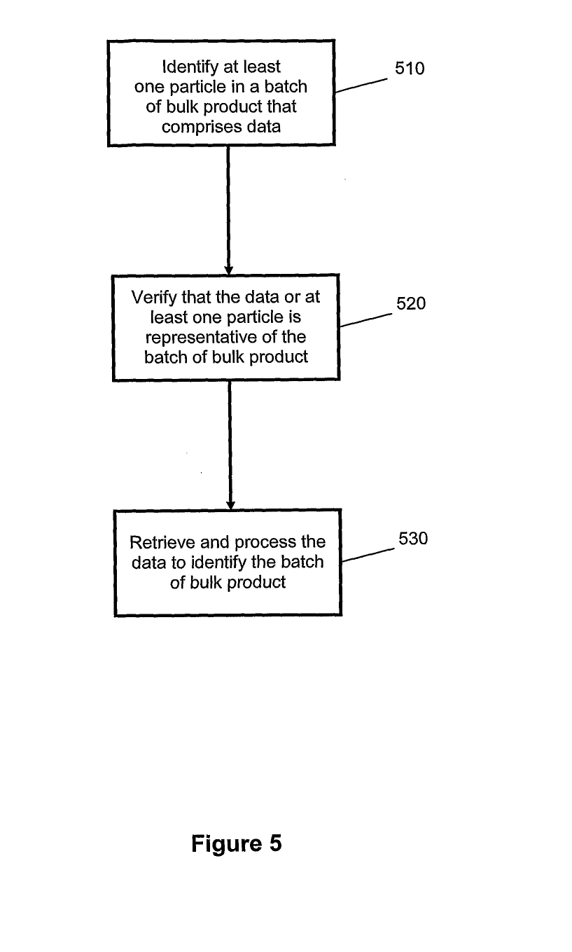

FIG. 5 is a flowchart of a method for identifying a batch of bulk product comprising particles in accordance with an embodiment of the present invention.

Referring to FIG. 5, at least one particle in a batch of bulk product that comprises data for identifying the quantity of bulk product is identified at step 510. Identification of the at least one particle may be performed by activating a marker applied to the at least one particle and identifying the at least one particle by detecting a response to the activation that is detectable by a naked human eye. For example, identification of the at least one particle may be performed by detecting luminescence emitted in response to illumination by light of a particular wavelength.

Verification that the at least one particle and/or data is representative of the batch of bulk product is performed at step 520 by detecting presence of a marker (different to the marker of step 510) applied to both the at least one particle and one or more other particles in the batch of bulk product that do not comprise data. Presence of the marker is detectable in response to activation of said marker. For example, presence of the marker may be detected by detecting a spectral response emitted by the marker in response to activation, which is undetectable by a naked human eye. It should be noted that step 520 may be performed before or after step 510.

The data is retrieved from the at least one particle and processed to identify the batch of bulk product at step 530. Retrieval of the data from the at least one particle typically comprises magnifying and reading the data, for example, with the aid of an electron or optical microscope, or another optical lens arrangement.

### General Observations:

The following general observations were made from the foregoing examples and other tests that were performed:

The lighter the colouring of the seed pellets, the less the visual difference between the seed pellets treated with marker dye (UV) and the other seed pellets (although there is nevertheless a suitable difference for distinguishing, particularly when viewed in darker conditions). To maximize the contrast, the marker dye may be specifically selected to glow with particular, high contrast colours relative to the colour of the seed pellets.

The darker the seed pellet colour, the better the visualization of the marker dye under UV illumination on the seed pellets.

The lighter the pellet colour and the bigger the microdots, the easier it is to find the microdots visually using a suitable microscope.

The surface area of the seed pellets determines the optimum size of the microdot used. Smaller seed pellets don't physically allow for the successful attachment of larger microdots.

The portion of seed pellets having one or more microdots attached thereto comprise a small fraction of the total number of seed pellets. In particular, the average number of seed pellets having one or more microdots attached thereto in the examples above is typically 10% or less of the total number of seed pellets.

The invention is not confined to the colours described above, but can be applied to the full spectrum of colours, including grey and black. The rates of the Datatrace product required for ready detection using the Datatrace electronic scanner varies slightly but does not affect the technique.

The techniques can be applied to a wide range of coating technologies for “Seed Coating”, including Film Coating (Basic polymer coat), Encrustment (Up to 250% build up), Pelleting (250%+build up), and other technologies. Whilst the % additives required may vary in such applications, the tests in all cases were successful.

A further embodiment provides a means of locating and (low-level) authenticating target seeds at a distance, including in the dark and/or through certain objects and materials. The ability to detect emissions at a distance, even in the presence of ambient light, is very useful. Furthermore, detection of emissions through materials such as paper, polymer, cloth, and soil is also very useful. This advantageously enables detection of the presence of marked seeds in packaging. Similarly, the ability to detect emissions from within soil enables location of target seeds, post-planting. This embodiment may be practised by coating target seeds with an infra-red (IR) reflective material and/or a luminescent material that activates, excites, and/or reports in the IR wavelength band. Wavelengths in the range of approximately 900 nm-1,000 nm are suitable for practising this embodiment. However, those skilled in the relevant arts will appreciate that other suitable wavelengths could alternatively be practised.

Another embodiment provides a means of locating, identifying and/or authenticating seeds using metameric colours and pairs or combinations of metameric colours. By law, the seed coating industry is required to colour treated seeds in order to prevent seeds containing potentially lethal chemicals from becoming entrained in the food supply. The use of metameric colours makes it possible to mark one seed batch as being distinct from another, whilst marking the seed with a visibly specific colour. Metameric colour combinations are spectrally distinct but perceptually identical in given lighting conditions. An advantage of metameric techniques is that they provide a low cost way of marking seed and a low cost means of detecting marked seed in the field. Metameric detector systems may be entirely passive, such as filters. A simple filter can be used to detect a simple metameric material containing a small number of reflective spectral bands. A sophisticated metameric material using a multiplicity of spectral reflection bands could be addressed by a sophisticated yet passive filter-based detector.

An example of how such a low cost yet sophisticated filter system could be applied in the field is demonstrated by the 3D spectroscopic glasses supplied with the ‘Real-3D’ system made and sold by RealD Inc. This is presently the most widely used technology for watching 3D films in theatres. The Real-3D glasses have two lenses that assign each stereo channel mutually exclusive pass bands in each of the red, green and blue. By programming a custom filter that responds to the bands of the metamer, a pair of such glasses worn by a user would provide a convenient and low cost means of locating the marked seeds.

Another method of detecting the presence of metameric materials comprises subjecting the particular material to examples of spectrally distinct lighting.

Yet another method of detecting the presence of metameric materials involves analysis of the particular material with a spectrometer.

The foregoing description provides exemplary embodiments only, and is not intended to limit the scope, applicability or configurations of the invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter

1. A method for identifying a batch of bulk product comprising particles, said method comprising the steps of:
identifying at least one particle in said batch of bulk product that comprises data for identifying said quantity of bulk product;
verifying that said data is representative of said batch of bulk product by detecting presence of a first marker applied to said at least one particle and one or more other particles in said batch of bulk product that do not comprise said data, wherein presence of said first marker is detectable in response to activation of said first marker; and
retrieving said data from said at least one particle and processing said data to identify said batch of bulk product.

2. The method of claim 1, wherein said step of identifying said at least one particle comprises the sub-steps of:
activating a second marker applied to said at least one particle; and
identifying said at least one particle by detecting a response to said activation;
wherein said response is detectable by a naked human eye.

3. The method of claim 2, wherein said second marker is detected by detecting luminescence emitted in response to illumination by light of a particular wavelength.

4. The method of claim 1, wherein presence of said first marker is detected by detecting a spectral response emitted by said first marker in response to activation; and
wherein said spectral response is undetectable by a naked human eye.

5. The method of claim 1, wherein said step of retrieving said data from said at least one particle comprises the steps of magnifying and reading said data.

6. The method of claim 1, wherein said step of retrieving said data from said at least one particle comprises the step of reading said data using an electron or optical microscope.

7. The method of claim 1, wherein said bulk product comprises agricultural seed or grain.

8. A method for facilitating identification of a batch of bulk product comprising particles, said method comprising the steps of:
applying a taggant to a quantity of particles of size approximately equal to particles that comprise said bulk product, said taggant comprising data for identifying said batch of bulk product;
applying a first marker to said quantity of particles, said first marker adapted to emit a response to activation that is visible to a naked human eye; and
adding said quantity of particles to said batch of bulk product.

9. The method of claim 8, comprising the further step of:
applying a second marker to all particles in said batch of bulk product, said second marker adapted to emit a spectroscopic response to activation that is invisible to a naked human eye.

10. The method of claim 8, wherein said taggant comprises microdots attached to the surface of said quantity of particles, said microdots comprising data for identifying said batch of bulk product.

11. The method of claim 8, wherein said first marker comprises a coating applied to said quantity of particles, wherein said coating is adapted to emit luminescence in response to illumination by light of a particular wavelength.

12. The method of claim 8, wherein said second marker comprises a coating applied to all particles in said batch of bulk product, wherein said coating is adapted to emit a spectroscopic response when activated.

13. The method of claim 8, wherein said quantity of particles comprises particles of said bulk product.

14. The method of claim 8, wherein said quantity of particles comprises agricultural seed or grain.

15. The method of claim 8, wherein said bulk product comprises agricultural seed or grain.

16. A batch of bulk product comprising particles, wherein:
each particle in said batch has a first marker applied thereto, said first marker adapted to emit a response invisible to a naked human eye when activated; and
a portion of said particles have a taggant and a second marker applied thereto, said taggant comprising data for identifying said batch of bulk product and said second marker adapted to emit a response visible to a naked human eye in response to activation.

17. The batch of bulk product of claim 16, wherein said taggant comprises microdots attached to the surface of said portion of particles, said microdots comprising data for identifying said batch of bulk product.

18. The batch of bulk product of claim 16, wherein said first marker comprises a coating applied to said portion of particles, said coating adapted to emit luminescence in response to illumination by light of a particular wavelength.

19. The batch of bulk product of claim 16, wherein said second marker comprises a coating applied to all particles in said batch of bulk product, said coating adapted to emit a spectroscopic response when activated.

20. The batch of bulk product of claim 16, wherein said portion of particles comprises an average amount of 10% or less of the total particles in said batch of bulk product.

21. The batch of bulk product of claim 16, wherein said bulk product comprises agricultural seed or grain.

22. The batch of bulk product of claim 16, wherein said quantity of particles comprises agricultural seed or grain.
